(19) United States
(12) Patent Application Publication
(10) Pub. No.: US 2008/0168978 A1
(43) Pub. Date: Jul. 17, 2008

(54) Machine for a twig burning camp stove

(76) Inventor: David Willard Crimmins, Prescott, AZ (US)

Correspondence Address: David Willard Crimmins, 1390 Valley Runch Circle, Prescott, AZ, 86303, US

(21) Appl. No.: 11/654,432

(22) Filed: Jan. 16, 2007

(51) Int. Cl. A47J 37/00

(52) U.S. Cl. 126/25 R

(57) ABSTRACT

A machine for twig burning camp stove with, and utilizing a venturi or natural physical vacuum to create air flow to assist in the burning of fuel, a cylinder to elevate the machine, and providing a pedestal to place a pan or other cooking surface; with an attached smaller diameter pipe coming out of the top of one side of the cylinder, acting as a constricted throat; in conjunction with a larger diameter pipe or feeder hole coming from the opposite side and at the lower section of the cylinder; working together to create air flow through the cylinder up and out; to efficiently burn twigs for the use of cooking in the out of doors; overall smaller or larger machines may be utilized for different cooking situations; examples being backpacking to larger family outings.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of camping stoves and more specifically to a machine for twig burning camp stove.

Cooking while camping has, until more recently, been done mainly over an open fire.

Coals from burned wood were primarily used to cook the food.

Cooking food while camping has been accomplished, in modern times, both with an open fire pit or with the use of various cooking stoves using a variety of different fuels and fuel delivery systems.

Most systems are comprised of fuel canisters containing propane, white gas, and others. Also barbeque grills using charcoal briquettes have provided the ability to cook food in a camping setting.

While providing adequate heat for food cooking in a camping or outdoor setting the average and most widely used devices create waste and cost money upon every use.

Refillable or disposable gas canisters must be used for gas fueled stoves. Bags of charcoal briquettes, utilized for barbeque cooking must be purchased and manufactured to cook food in this way.

### BRIEF SUMMARY OF THE INVENTION

The primary object of the invention is to provide a camping stove that uses only twigs for fuel.

Another object of the invention is to provide a camping stove that has no moving parts or fuel canisters.

Another object of the invention is to provide the most efficient fuel burning camping stove.

A further object of the invention is to provide a portable and light weight camping stove.

Yet another object of the invention is to provide a camping stove where as no fuel will ever need to be purchased.

Still yet another object of the invention is to provide a camping stove where fuel is readily available at any camping site.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for a twig burning camp stove comprising: and utilizing a venturi or natural physical vacuum to create air flow to assist in the burning of fuel twigs; a cylinder base with feeder inlet pipe and a restricted or slightly smaller outlet throat; and a cooking surface placed upon the top rim of the cylinder

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

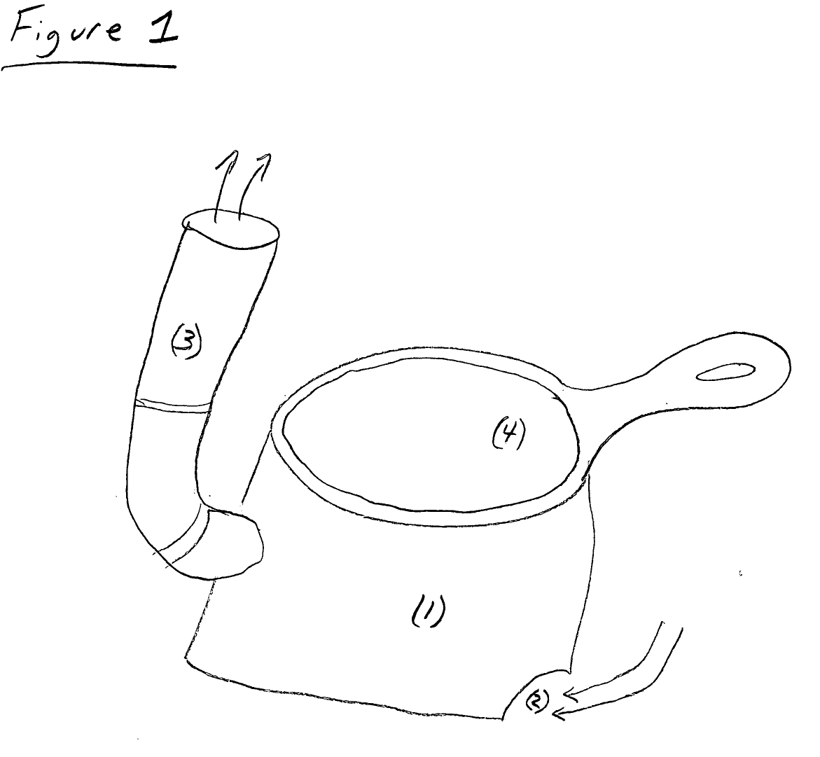

Turning to FIG. 1 the description of the twig burning camp stove is as follows:

A machine for a twig burning camp stove comprising and utilizing a venturi or natural physical vacuum to create air flow to assist in the burning of fuel twigs.

Traditionally a camping stove has been fueled with the aid of gas fuel canisters or the use of different types of combustible gas. The twig burning camp stove requires none of this. Only twigs found at any camping location to burn and provide adequate heat for most any type of outdoor cooking. The design presented here creates a highly efficient fuel burning environment within the apparatus.

As described in the original claim, a metal cylinder(1) 12 inches in diameter on the bottom and 10 inches in diameter on top is the fire box and will elevate the cooking surface above the ground.

A notch(2) 4 inches in diameter can be a cutout in the side of the cylinder or a 4 inch diameter feeder pipe can be placed into the lower part of one side of the cylinder.

On the opposite side and farther upon the cylinder a curved (3) 3 inch metal pipe is unitarily attached and utilized as a chimney or constricted throat.

Finally, the last piece of the apparatus is a pan (4), or other cooking surface of some kind shall be placed upon the top diameter of the cylinder to cook food upon.

A shallow hole should be dug just below the cylinder giving the fire box more space.

Place tinder and twigs within and when lit the venturi will begin to work. More fuel twigs can be added via the feeder pipe during cooking as needed.

Oxygen will be pulled through the 4 inch feeder pipe and then up through and out of the 3 inch chimney or exhaust pipe. The action of the venturi acts similar to blowing on a burning fire.

The fire burns efficiently and very hot utilizing all of the available fuel from the twigs and creates an almost smokeless exhaust.

The advantage of using the twig burning camp stove are that no purchase shall need to be made after the initial stove purchase. No fuel canisters or gas fuel are necessary.

It is portable, light weight with no moving parts and can be used with an array of different cooking surface pans or pots. It is simply the easiest, most efficient, and sustainable way to cook in the great outdoors.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for a twig burning camp stove comprising:
and utilizing a venturi or natural physical vacuum to create air flow to assist in the burning of fuel.

2. a machine as in claim 1 wherein a metal cylinder 12 inches in diameter on the bottom and 10 inches in diameter on top, will elevate the machine above the ground

3. a machine as in claim 1 wherein a 3 inch diameter curved metal pipe is unitary with the cylinder and working as a constricted throat

4. a machine as in claim 1 wherein a 4 inch diameter metal pipe or equivalent cutout is unitary with the cylinder used as a feeder for oxygen and fuel

5. a machine as in claim 1 wherein a 10 inch diameter cooking pan is placed upon the top of the cylinder apparatus
